(19) United States
(12) Patent Application Publication
(10) Pub. No.: US 2007/0223525 A1
(43) Pub. Date: Sep. 27, 2007

(54) TRANSMISSION OF PACKETS IN A CSMA WIRELESS NETWORK

(75) Inventors: Divyesh Kumar Shah, Bangalore (IN); Girish Anantrao Madpuwar, Bangalore (IN); Mayank Jain, New Delhi (IN)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/688,925

(22) Filed: Mar. 21, 2007

Related U.S. Application Data
(60) Provisional application No. 60/784,526, filed on Mar. 21, 2006.
(60) Provisional application No. 60/784,523, filed on Mar. 21, 2006.

(51) Int. Cl. H04J 3/22

(52) U.S. Cl. 370/468

(57) ABSTRACT

A wireless device containing a physical layer (in a transceiver) which generates multiple status signals indicating the status of the wireless medium at different time instances. The status signals are examined to determine a time instance after which the medium is available to transmit the packets. In an embodiment, one status signal indicates whether valid preamble bits are being received on (before end of the preamble) the wireless medium consistent with the 802.11a standard and another status signal indicates similar status but for 802.11b standard. The embodiment further includes a qualification logic, which determines a time instance after which the availability of medium is determined.

### RELATED APPLICATION

The present application claims priority from co-pending U.S. provisional patent application Ser. No. 60/784,526 filed on Mar. 21, 2006, attorney docket number: TI-61335 PS, naming as inventors Madpuwar et al, entitled, “Fuzzy decision on WLAN response frame”, and is incorporated in its entirety herewith.

### BACKGROUND

1. Field of the Invention

The present invention relates generally to networks, and more specifically to improved transmission of packets in a CSMA wireless network.

2. Related Art

Carrier sense multiple access (CSMA) based wireless networks are often used to connect multiple wireless devices. In general, in CSMA based networks, each device senses whether the shared medium provided by the network is available (not used by other devices), and transmits the desired signal when the medium is available.

In some environments, the medium provides multiple channels and the availability of a channel may be checked. In the case of wireless technologies, a channel may be established using techniques/technologies such as carrier sense multiple access (CSMA/CA) as is well known in the relevant arts. In technologies where multiple channels are not provided on the wireless medium, the medium may be viewed as providing a single channel.

The time instance at which a wireless device in a CSMA network may transmit a data packet generally depends on a determination of whether the communication channel (channel in the description henceforth) is free. As an example, according to the 802.11 standard, a device needing to transmit must first sense the channel for the absence of any other transmissions (valid wireless network signal).

On determining the absence of any valid wireless network activity signals, the device may then wait for a time duration determined by the sum of a predetermined interval and a random interval (called a back-off), and at the end of the time duration may transmit data packets. The predetermined interval may vary depending on the current mode of operation as defined in the corresponding wireless network standard.

In general, waiting for too long a time, due to false detection (e.g., due to interference) before transmitting data packets may reduce overall throughput. On the other hand, transmitting too early, due to false rejection of a valid wireless network activity, may cause a collision with a valid data packet already present in the channel and result in violation of the protocol.

Several aspects of the present invention provide for improved transmission of data packets by overcoming one or more of problems such as false detection and false rejection noted above.

### BRIEF DESCRIPTION OF THE DRAWINGS

The present invention will be described with reference to the following accompanying drawings, which are described briefly below.

FIG. (FIG.) 1 is a block diagram illustrating an example environment in which various aspects of the present invention can be implemented.

FIG. 2 is a timing diagram illustrating a transmit sequence in one prior embodiment.

FIG. 3 is a flowchart illustrating the manner in which packets are transmitted according to an aspect of the present invention.

FIGS. 4a and 4b are example timing diagrams illustrating an improved transmit sequence in an embodiment of the present invention.

FIG. 5 is a block diagram illustrating the details of a wireless device in an embodiment of the present invention.

FIG. 6 is a block diagram illustrating the details of a decision block in an embodiment.

FIG. 7 is a timing diagram illustrating the retransmit sequence in a prior embodiment.

FIG. 8 is a state transition diagram illustrating the sequence of states in determining channel status in one embodiment.

FIGS. 9A and 9B are example timing diagrams illustrating an improved retransmit sequence according to an aspect of the present invention.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Overview

A wireless device operating in a CSMA network provided according to an aspect of the present invention contains a physical layer (in a transceiver) which generates multiple status signals indicating the status of the wireless medium at different time instances. The status signals are examined to determine a time instance after which the medium is available to transmit the packets.

Due to the use of such multiple status signals, the status of availability of the wireless medium can be determined with a desired degree of certainty at different time instances.

In an embodiment, one status signal indicates whether valid preamble bits are being received on (before end of the preamble) the wireless medium consistent with the 802.11a standard and another status signal indicates similar status but for 802.11b standard. According to another aspect of the present invention, the embodiment includes a qualification logic, which determines a time instance after which the availability of medium (for transmission) is determined.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well known structures or operations are not shown in detail to avoid obscuring the features of the invention.

### 2. Example Device/System

FIG. 1 is a block diagram illustrating an example environment in which several aspects of the present invention may be implemented. The diagram is shown containing two Basic Service Sets (BSS) 110 and 120, wired network 130, and wired network backbone 140. In the example environment shown in FIG. 1, the respective components may operate consistent with the 802.11 WLAN standard. However, the features can be implemented in various other CSMA environments as well. Each component of FIG. 1 is described in detail below.

BSS 110 contains wireless devices (clients) 110-A through 110-E and access point (AP) 110-F. Each of wireless devices 110-A through 110-E may be any electronic/computing device (mobile or fixed) equipped with a wireless network interface card (or similar hardware) that enables wireless communication. Wireless devices 110-A through 110-E may be devices such as laptops, desktops, Personal Digital Assistants (PDA) etc.

AP 110-F is connected by a wired medium (141) to wired network backbone 140, which in turn is connected to wired network 130. AP 110-F provides wireless devices 110-A through 110-E connectivity with each other. Thus, for example, if wireless device 110-A is to communicate (transfer data to) with wireless device 110-C it may do so by first communicating with AP 110-F, which in turn communicates with wireless device 110-C. Thus, a wireless device 110-A/110-E wanting to communicate with another wireless device 110-A/110-E may do so via AP 110-F. AP 110-F also provides wireless devices 110-A through 110-E connectivity to wired network 130 and BSS 120. Each of wireless devices 110-A through 110-E in BSS 110 may also communicate with each other directly, without requiring the presence of AP 110-F.

BSS 120 and constituent components wireless devices 120-A through 120-E and AP 120-F operate in a manner similar to that described above with respect to BSS 110, and the related description is not repeated here for the sake of conciseness.

All devices in BSS 110 and BSS 120 may communicate with each other on a shared frequency band such as the 2.4 GHz (or 5.1 GHz) band specified by the WLAN standard. The devices could be operating in the same channel or different channels (adjacent or overlapping) within the shared band.

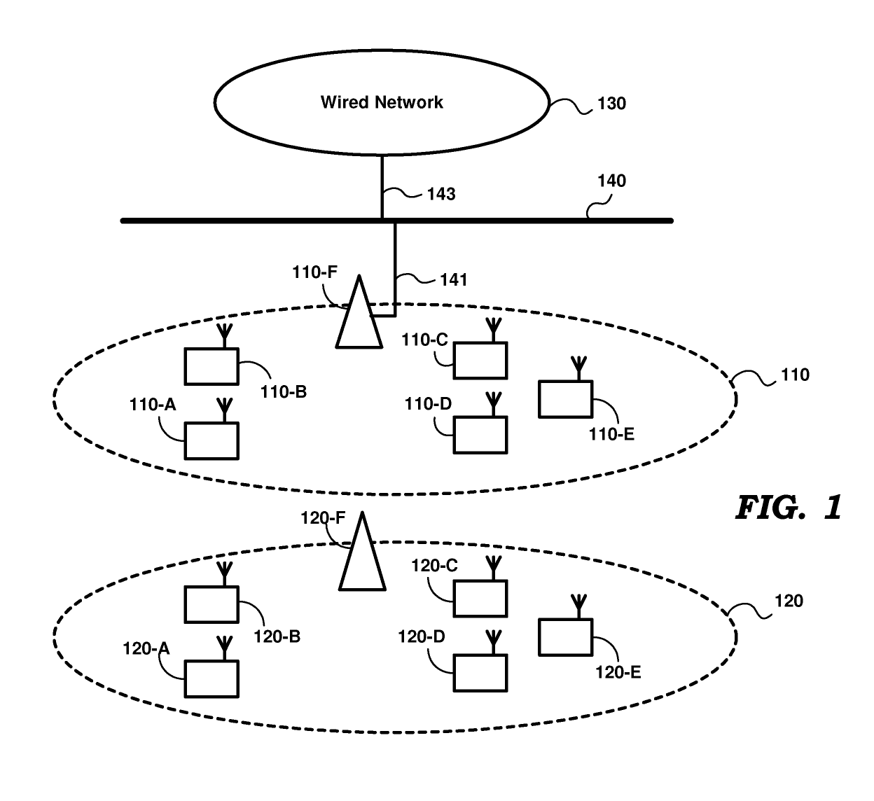

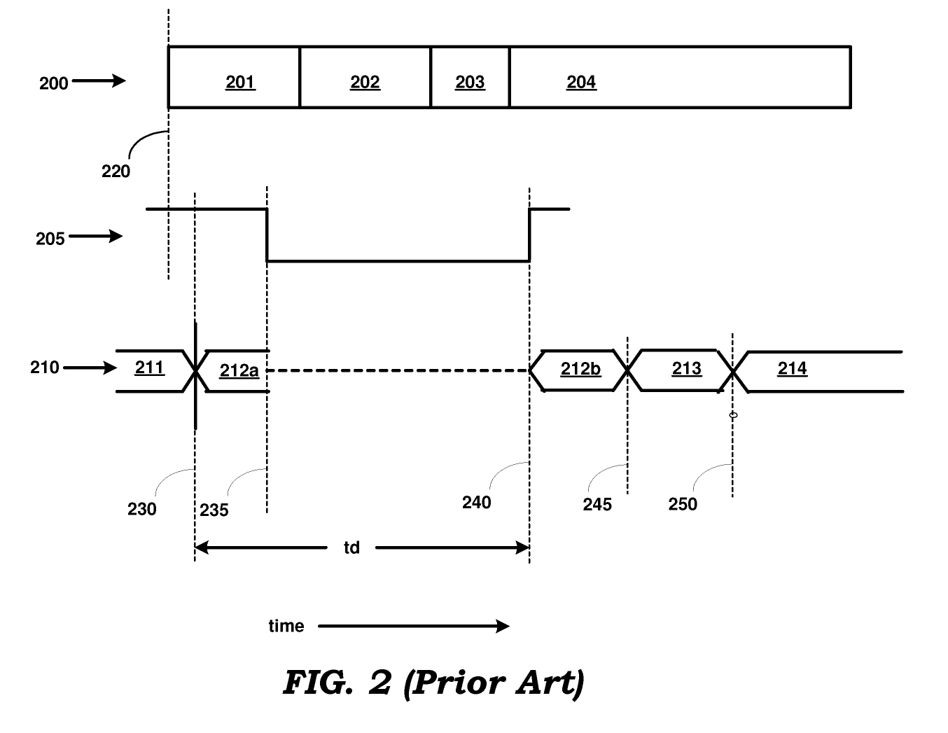

As noted above, any of wireless devices in BSS 110 requiring to transmit data packets must first wait for the communication channel (shared medium, in general) to be free from other transmissions. In the event other transmissions (whether spurious or not) are detected in the channel, each device must take appropriate steps to wait for the channel to become free and prepare for transmission once the channel is indicated to be free. Accordingly, a prior Transmit Sequence is described next with respect to FIG. 2.

### 3. Transmit Sequence

FIG. 2 is a timing diagram of a (prior) Transmit Sequence as might be employed in the environment of FIG. 1 assuming operation according to the 802.11 WLAN standard. As will become apparent from the description below, the diagram illustrates the manner in which the presence of possible noise (signals such as interference signals, in general, potentially signals representing anything other than a valid data packet in the same BSS, such as activity in adjacent/overlapping channels, microwave bursts, cordless phone interference, continuous wave/carriers, etc.) in the shared medium may affect the transmit instance of a data packet from wireless device 110-A. Merely for ease of description, it assumed in the description below that a transmission by any wireless device in BSS 120 causes (represents) adjacent channel interference for wireless device 110A.

Waveform 210 represents a sequence of tasks performed for transmission in wireless device 110-A. In particular, 211 represents the formation of a packet in wireless device 110-A, and may include various other internal operations in wireless device 110-A, such as creation of headers (MAC, PLCP etc.), encryption of payload data (assuming encryption is to be performed), determination of whether to format data according to 802.11a or 802.11b specifications etc. It is assumed that the operations leading to formation of the packet commences at a time instance earlier than 220. Other operations denoted by fields/numbers 212, 213, 214 and 215 are described below.

Signal 205 represents the value (state) of a CCA (clear channel assessment, defined and described in 802.11 WLAN standard) signal in wireless device 110-A indicating whether the channel is free for transmission or not, and is shown as logic high (1) before time instance 220 (indicating channel is free).

Signal 200 represents a signal that might be present in the shared medium, and may correspond to an actual data packet transmitted by a device (other than wireless device 110-A) in BSS 110, a data packet transmitted by a device in BSS 120 (thus representing adjacent-channel interference), or (although shown as a data packet) noise due to effects such as those noted earlier.

Assuming the signal represents a valid data packet according to 802.11a standard, field 201 (SS) denotes a short-sequence preamble, field 202 (LS) is a long-sequence preamble, field 203 is a PLCP (Physical Layer Convergence Procedure) header, and field 204 is the data payload including identification headers.

Signal 200 starts at time instance 220. At time instance 230, wireless device 110A commences preparation for transmission by starting to count a time interval equal to a DIFS (Distributed Coordination Function Interframe Space according to the 802.11 standard) interval, as denoted by field 212a.

However, at time instance 235, CCA signal 205 goes to logic low (0) indicating the detection of signal 200 in the shared medium. In response, wireless device 110-A suspends its preparation to transmit at time instance 235, and resets the counter/timer that counts the DIFS interval. Field 212a thus represents a partial countdown of the DIFS interval, and wireless device 110-A waits for CCA signal 205 to go to logic high (1) indicating that the channel is free. It may be noted that the time period between time instances 220 and 235 has a maximum limit as specified by the 802.11 standard to ensure detection of valid activity in the wireless channel early enough to avoid collisions.

At time instance 240, CCA signal 205 goes to logic 1 indicating channel is free. Such a determination may be made if the CCA logic finds an absence of any signal in the channel. In response, wireless device 110-A again initiates counting of the (entire) DIFS interval, as indicated by field 212b. At the end of the DIFS period 212b (time instance 245), wireless device 110-A starts countdown of the back-off timers. When the back-off timers reach zero (end of count) at time instance 250, wireless device 110-A begins transmission of a data packet as indicated by field 214. Operations denoted by fields 212 and 213 may be considered as preparation for transmission. It is noted here, that if CCA signal 205 had gone to logic 0 when the back-off interval counting (depicted by field 213) had started, then the back-off interval counting would be frozen (rather than reset as in the case of the DIFS interval), and counting would continue again when CCA signal 205 goes to logic 1.

It may be appreciated from the above description, that transmission by wireless device 110-A has been effectively delayed by a time duration ‘td’ (where ‘td’ is duration of false detection, and as indicated in FIG. 2), which may lead to a reduction in throughput performance.

The description is continued with a flowchart illustrating the manner in which determination of an optimal time instance to transmit data packets may be made in an embodiment.

### 4. Determination of Optimal Time Instance to Transmit Data Packets

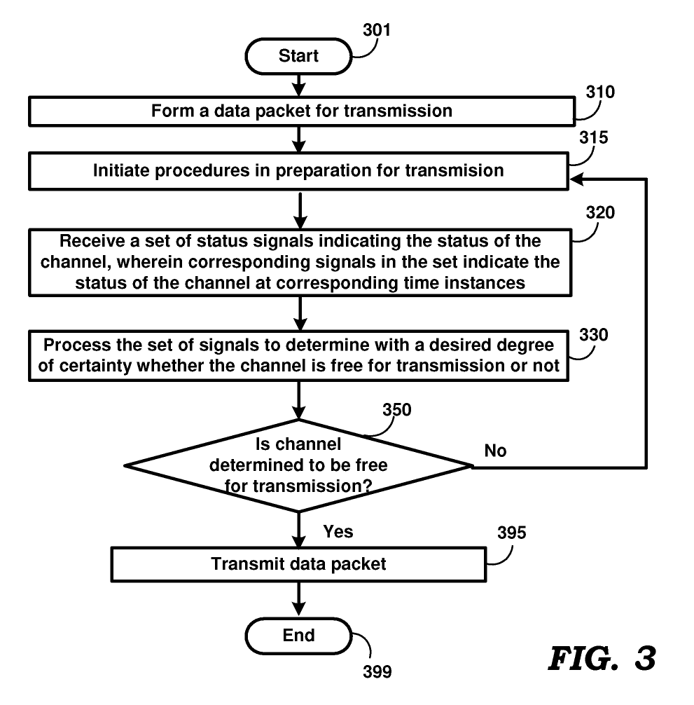

FIG. 3 is a flowchart illustrating the manner in which an optimal time to transmit may be determined in one embodiment. The flowchart is described with respect to FIG. 1, and in relation to wireless device 110-A, merely for illustration. However, various features can be implemented in other environments and other components. Furthermore, the steps are described in a specific sequence merely for illustration.

Alternative embodiments in other environments, using other components, and different sequence of steps can also be implemented without departing from the scope and spirit of several aspects of the present invention, as will be apparent to one skilled in the relevant arts by reading the disclosure provided herein. Further, although shown as operating sequentially, one or more of the steps described below may operate concurrently as noted by examples with respect to steps 320, 330, and 350. The flowchart starts in step 301, in which control passes immediately to step 310.

In step 310, wireless device 110-A forms a data packet for transmission. The data packet may be formed according to a corresponding format (802.11 in the case of the environment of FIG. 1). Control then passes to step 315.

In step 315, wireless device 110-A may initiate procedures in preparation for transmission. In an embodiment described below, wireless device 110-A enables down-counting for counting the DIFS interval and back-off interval. Wireless device 110-A may also initiate other operations in preparation for transmission consistent with the corresponding operating environment and specific device implementation. Control then passes to step 320.

In step 320, wireless device 110-A receives a set of status signals indicating the status of the channel, wherein corresponding signals in the set indicate the status of the channel at corresponding time instances. Each signal may indicate the status of the channel by sensing (or measuring) a corresponding characteristic of the activity in the channel. In an embodiment described below, wireless device 110-A receives four such signals. The status signals may be determined (and thereafter received) at correspondingly different time instances, and therefore, as noted above, step 320 as well as steps 330 and 350 may operate concurrently as described below. Control then passes to step 330.

In step 330, wireless device 110-A processes the set of status signals received to determine with a desired degree of certainty that the channel is free for transmission. Thus, processing of only a first signal (on receipt of the first signal) may yield channel status with a low degree of certainty, processing of a second signal (for example, received later in time) may yield channel status with a higher degree of certainty, etc. A desired degree of certainty (or confidence level) may be stored in advance (or transmitted dynamically to, in general, made available to) wireless device 110-A. Although shown as being in sequence, steps 320 and 330 may operate concurrently, and repeatedly till wireless device 110-A determines with a desired degree of certainty either that the channel is free for transmission or that a valid data packet is present in the channel. Control then passes to step 350.

In step 350, wireless device 110-A checks whether processing (in steps above) indicates that the channel is free for transmission. If the channel is indicated to be free for transmission, control passes to step 395, else control passes to step 315, in which the procedures in preparation for transmission are further processed in view of the channel determined not to be free for transmission, as described below. In step 395, wireless device 110-A transmits the data packet (or more than one data packet one after the other if more than one packet was formed in step 310 and if the wireless protocol permits such transmission). Control then passes to step 399 in which the flowchart ends.

Due to the use of such multiple status signals and potentially continuing the preparation process for transmitting data packets, delays in transmission may be reduced at least in some instances as described below with examples. The operation of the steps above are illustrated first with example timing diagrams.

### 5. Improved Transmit Sequence

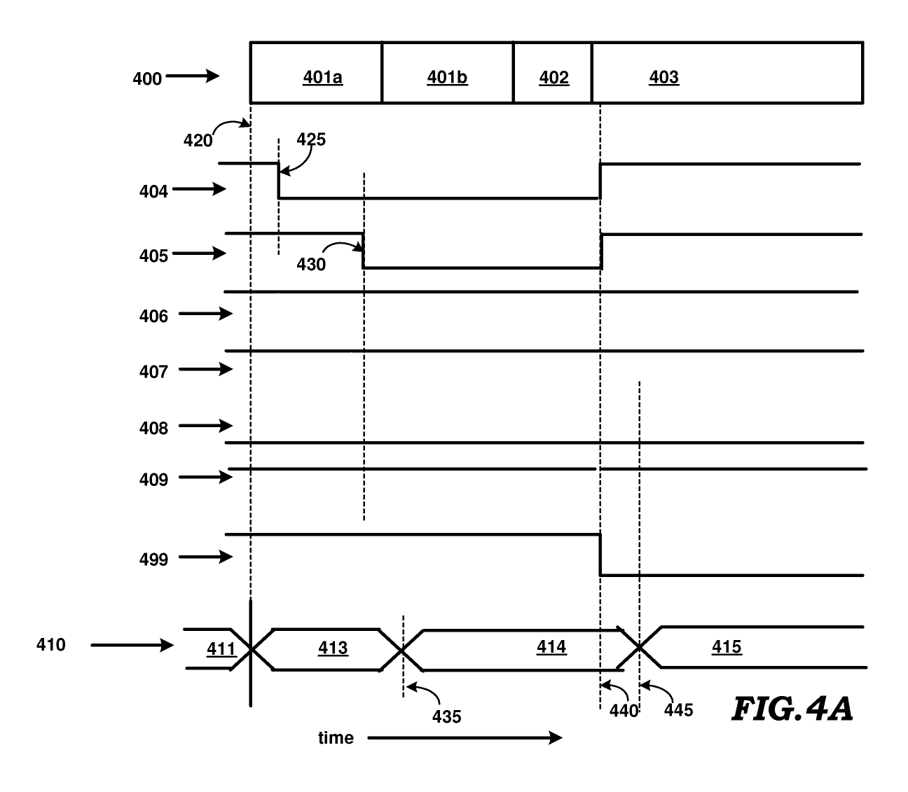

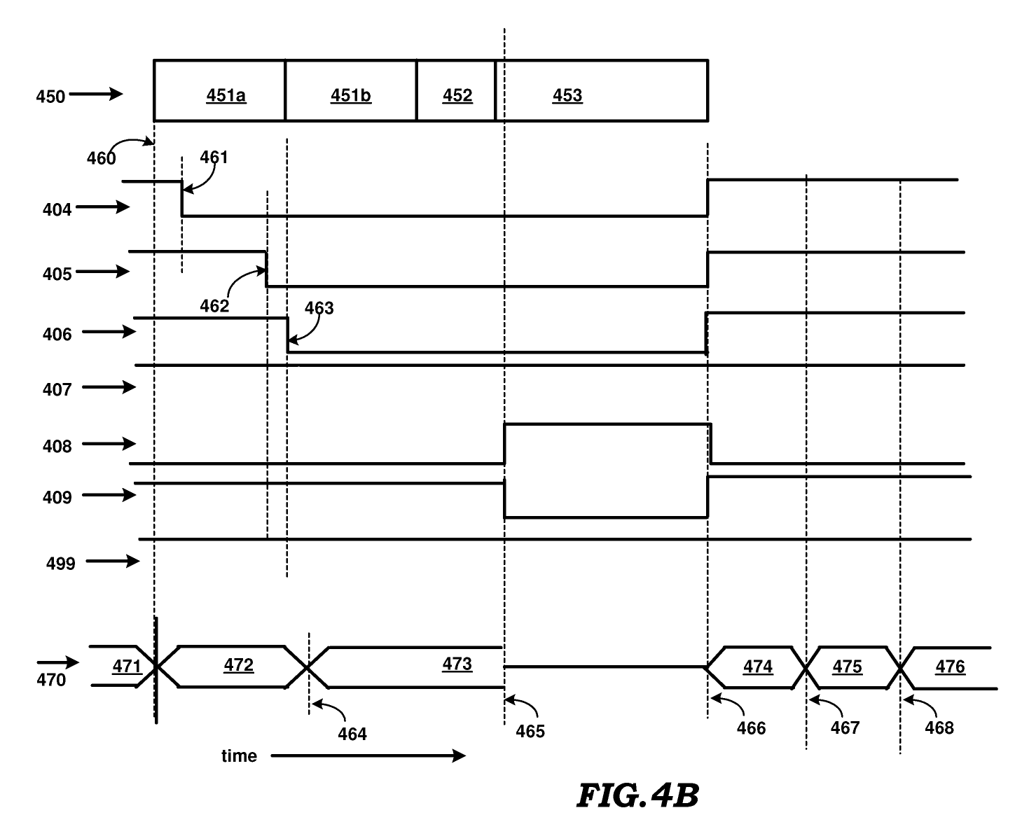

FIG. 4a is a timing diagram illustrating an improved Transmit Sequence in one embodiment, and illustrates a scenario in which a signal in the channel is determined not to be a valid wireless data packet, i.e., a false detect scenario. It must be understood that the logic levels of the signals/waveforms and time sequence of events are as shown merely by way of example. Other logic level combinations for the signals/waveforms and different time sequence of events may also be possible, and lie within the scope of several aspects of the present invention.

Status signal 404 may be asserted (e.g., to logic 0) if the signal energy in the channel as seen/received by an antenna used in wireless device 110-A crosses a specified threshold (thus indicating the presence of any detected signal.

Status signal 405 may be asserted (e.g., to logic 0) if the signal energy in the channel as seen/received by an antenna, but contained within a bandwidth of interest crosses a specified threshold. The bandwidth of interest may correspond to the band used for transmission/reception by wireless devices in the environment of FIG. 1, and thus status signal 405 may be more indicative of whether the signal represents a valid data packet or not.

Status signal 406 may be asserted (e.g., to logic 0) if a valid 802.11a preamble is detected. Thus, with respect to FIG. 4a, status signal 406 may be designed to indicate the status based on, for example, analyzing the contents in fields 401a and 401b of signal 400 (but transmitted by some other wireless devices). How soon (early) status signal 406 is asserted may be based on an accuracy with which the contents of fields 401 and 402 may be determined given a signal strength, other interference sources, design of the logic for signal 406 etc. Status signal 407 is designed to detect the presence of valid preamble bits of 802.11b data packets, and may be implemented using active low logic.

Decision signal 408 is provided to a timer block (described below) in wireless device 110-A. When decision signal 408 is asserted (e.g., to logic 0), it enables down-counting of timers/counters used for back-off interval counting and DIFS interval counting. When de-asserted (e.g., to logic 0), it disables down-counting of timers/counters used for back-off interval counting and DIFS interval counting. Decision signal 409 may be asserted (e.g., to logic 0) in response to a final decision that channel contains a valid wireless data packet. Abort signal 499 may be asserted (e.g., to logic 0) in response to a determination that channel does not contain a valid wireless data packet. Thus, signals 409 and 499 may together be used to indicate a final decision whether to transmit or not, as described below.

Decision signals 408 and 409 may be implemented as logical functions of status signals 404-407 and one or more qualifying signals. The qualifying signals may be chosen to indicate a specific time instance at which the signal levels decision signals 408 and 409 are to be checked when deciding to transmit a data packet or not. Thus, signals 408 and 409 represent the result of processing of status signals 404-407, and are indicative of a degree of certainty with which determination of channel status may be made.

As described in detail in sections below, decision signals 408 and 409 may be obtained by selecting one of several logical combinations (functions) of status signals 404-407 and the qualifying signals. The specific function chosen for the implementation may be user configurable, and based on a degree of certainty desired for the determination of channel status. The desired degree of certainty may in turn be based on factors such as operating environment, channel noise characteristics, sensitivity of receiver section of wireless device 110-A etc.

Signal 400 represents a signal that might be present in the shared medium, and may correspond to an actual data packet transmitted by a device (other than wireless device 110-A) in BSS 110, a data packet transmitted by a device in BSS 120 (thus representing adjacent-channel interference, assuming BSS 120 is configured to communicate on a different channel), or noise. If the signal represents a valid data packet according to the 802.11a standard, field 401a (SS) denotes a short-sequence preamble, field 401b (LS) is a long-sequence preamble, field 402 is a PLCP header, and field 403 is the data payload including identification headers.

Waveform 410 represents an improved transmit (TX) procedure in wireless device 110-A according to an aspect of the present invention. It is assumed that the TX procedure starts at a time instance earlier than 420. Field/number 411 represents the operations in wireless device 110-A leading to formation of a data packet (step 310 of the flowchart of FIG. 3). At time instance 420, wireless device 110-A initiates procedures in preparation for transmission (step 315 of the flowchart of FIG. 3). This is represented by field 413 in which wireless device 110-A waits for a time period equal to DIFS, and by decision signal 408 going to logic 1, thus enabling the timers/counters.

Signal 400 is shown as starting at time instance 420. At time instance 425, status signal 404 goes to logic low (0) indicating the detection of energy in the channel as received by the antenna. However, wireless device 110-A does not respond to this change and continues to enable procedures in preparation to transmit (including down-counting of DIFS interval or back-off interval, as applicable), as may be seen from field 413 at time instance 425, and the logic 0 (asserted) level of decision signal 408. Wireless device 110-A backs-up the value of the back-off interval count at time instance 425, for use at a later time point if needed.

At time instance 430, status signal 405 goes to logic low indicating that the energy detected in the channel within a bandwidth of interest (e.g., transmit/receive band of wireless device 110-A) exceeds a specified threshold. Again, wireless device 110-A does not respond to this change and continues to enable down-counting of DIFS interval or back-off interval, as applicable), as may be seen from field 413 at time instance 430, and the logic 0 (asserted) level of decision signal 408.

Status signal 406 remains at logic 1 (de-asserted) throughout in FIG. 4a, indicating that fields 401, 402 and 403 do not correspond to a valid 802.11a preamble, and thus that signal 400 is not valid 802.11a data packet. Status signal 407 also remains at logic 1 (de-asserted) in FIG. 4a, indicating that a valid 802.11b preamble is not detected, and thus that signal 400 is not a valid 802.11b data packet. Thus, transmit block of wireless device 110A continues with the preparation to transmit, as indicated by fields 413 and field 414. Field 414 represents the down counting of back-off timers (back-off interval), which is shown as commencing at time instance 435 and ending at time instance 445.

Assuming that qualifying signals have been specified to wireless device 110A such that time instance 440 denotes the time when processing of status signals 404-407 reaches a desired degree of certainty, decision signal 409 and abort signal 499 are checked at time instance 440. Time instance 440 is shown in FIG. 4a as occurring at the end of PLCP header (field 402). Since decision signal 409 is de-asserted and abort signal 499 is asserted, this signifies that no valid wireless packet is detected in the channel. In response, the transmit block of wireless device 110A commences transmission (field 415) of a data packet at time instances 445 (after the end of back-off interval 414). Assuming that duration of the back-off intervals 414 and 213 (FIG. 2) are equal, a delay in transmission by an amount delay ‘td’ noted in FIG. 2 is avoided.

In the description above, receiving and processing of signals 404-409 may correspond to steps 320 and 330 in the flowchart of FIG. 3. A ‘degree of certainty’ about the status of the channel is deemed to have exceeded a desired threshold at time instance 440 since neither status signal 406 nor status signal 407 have indicated detection of a valid data packet till such a time. The desired threshold may be specified by the manner in which decision signals 408 and 409 are generated from the status signals and qualifying signals.

In FIG. 4a, the qualifying signal is selected to correspond to time instance 440, which may in turn correspond to a time instance at which fields 401, 402 and 403 of a valid data packet (assuming one is present in the channel) may be examined to indicate presence or absence. If the desired threshold is lower, then only fields 401 (or only fields 401 and 402) may be examined. The selection of status signals and qualifying signals are configurable by a user. The energy thresholds to be used for status signals 404 and 405 are also configurable.

It may be noted from the description above that wireless device 110-A continues with procedures in preparation for transmission (unlike in the prior technique described with respect to FIG. 2) unless processing of the signals noted above indicates that the channel is not free, but instead contains a valid wireless data packet. A scenario in which wireless device 110-A determines that a valid data packet is present in the channel is described next respect to FIG. 4b.

FIG. 4b is a timing diagram illustrates a scenario in which a signal in the channel is determined to be a valid wireless data packet, i.e., a false reject scenario. In FIG. 4b, signals 404, 405, 406, 407, 408, 409 and 499 have the same meanings as in FIG. 4a.

Signal 450 represents a signal that might be present in the shared medium, and may correspond to an actual data packet transmitted by a device (other than wireless device 110-A) in BSS 110, a data packet transmitted by a device in BSS 120 (thus representing adjacent-channel interference, assuming that BSS 120 is configured to communicate on a different channel and thus may not transmit a packet that may be considered as valid by wireless device 110-A), or noise. If the signal represents a valid data packet according to the 802.11a standard, field 451a (SS) denotes a short-sequence preamble, field 451b (LS) is a long-sequence preamble, field 452 is a PLCP header, and field 453 is the data payload including identification headers.

Waveform 470 represents another example transmit sequence in wireless device 110-A. It is assumed that the transmit sequence starts at a time instance earlier than 460. Field/number 471 represents the operations in wireless device 110-A leading to formation of a data packet (step 310 of the flowchart of FIG. 3). At time instance 460, wireless device 110-A initiates procedures in preparation for transmission (step 315 of the flowchart of FIG. 3). This is represented by field 472 in which wireless device 110-A waits for a time period equal to DIFS.

At time instance 461, status signal 404 goes to logic low (0) indicating the detection of energy in the channel as received by the antenna. However, wireless device 110-A does not respond to this change as yet, and continues to enable procedures in preparation to transmit (including down-counting of DIFS interval or back-off interval, as applicable), as may be seen from field 472 at time instance 461, and the logic 0 (asserted) level of decision signal 408. Wireless device 110-A backs-up the value of the back-off interval count at time instance 461, for use at a later time point if needed.

At time instance 462, status signal 405 goes to logic low indicating that the energy detected in the channel within a bandwidth of interest (e.g., transmit/receive band of wireless device 110-A) exceeds a specified threshold. Again, wireless device 110-A does not respond to this change and continues to enable down-counting of DIFS interval or back-off interval, as applicable, as may be seen from field 472 at time instance 462, and the logic 0 (asserted) level of decision signal 408.

Status signal 406 is shown as going to logic 0 (asserted) at time instance 463 indicating that fields 401, 402 and 403 have been determined to correspond to a valid 802.11a preamble, and thus that signal 400 is a valid 802.11a data packet. (Status signal 407 remains at logic 1 throughout in FIG. 4b, indicating that a valid 802.11b preamble is not detected, and thus that signal 400 is not a valid 802.11b data packet). At time instance 464, wireless device commences countdown of the back-off interval (field 473).

Abort signal 499 remains de-asserted throughout indicating that there is no determination that a valid wireless data packet has not been detected. Assuming that qualifying signals have been specified to wireless device 110A such that time instance 465 denotes the time when processing of status signals 404-407 reaches a desired degree of certainty, decision signal 409 is asserted indicating the detection of a valid wireless data packet in the channel (thus confirming the indication by status signal 406). Thus, at time instance 465, transmit block of wireless device 110-A suspends the transmit sequence, freezes the downcounting of the back-off interval (signal 408 de-asserted at time instance 465), and waits for the end of the wireless data packet to be signaled.

End of wireless packet 450 is signaled at time instance 466, and signals 404, 405, 406 and 409 are de-asserted. Signal 408 is (re)asserted at time instance 466 enabling timer/counter operations. Transmit block of wireless device 110-A restarts the counting of the DIFS and back-off interval, as indicated by fields 474 and 475 respectively. Downcounting of the back-off interval starts at time instance 467, and ends at time instance 468, at which time point, wireless device 110-A commences transmission of a data packet (field 476).

It is to be noted that, had status signal 404 gone to logic 0 during a back-off counting interval (denoted by field 473), wireless device 110-A would restart counting of the entire DIFS interval, but at the end of the DIFS interval, the backed-up value (at time instance 461) of the back-off timer is restored, and the back-off interval counts down from the restored value. Further, if the back-off counter reaches a value zero before the degree of certainty is reached (e.g., time instance 465), the back-off counter is reloaded with the stored value, and the reloading and downcounting are repeated till the channel is determined to be free (end of presence of a valid data packet is indicated). This ensures that wireless device 110-A does not violate the 802.11 standard. Further, assuming more than one wireless device implements the features of the invention, such an approach also minimizes the probability of collisions taking place due to more than one such wireless device attempting to transmit when the channel becomes free.

Several aspects of the present invention also enable maintaining slot synchronization. As is known, it is desirable for all wireless devices in a network to be synchronized in time (for example, aligned to a basic time unit characterizing the wireless network termed as a time slot). According to 802.11 standards, back-off intervals are always in multiples of slot intervals, and aligned to slot boundaries, but a DIFS interval is not a multiple of slot intervals, as described below.

With reference to the description of FIG. 4A, it may be noted that at the first indication of a (possible) presence in the channel of a signal/packet (i.e., at time instance 425 in FIG. 4a), the value of the counter/timer counting the back-off interval is backed up. At the end of a back-off interval, if a determination still has not been made about channel status, the back-off timer is reloaded with the original count value, and count down is again performed. Thus, a transmission when commenced takes place only after the end of one or multiple back-off intervals. Since a back-off interval is always in multiples of the slot interval, it is ensured that transmission takes place aligned with a slot boundary. Wireless device 110-A thus maintains slot synchronization with other wireless devices in the network.

In contrast, referring to the prior technique of FIG. 2, it may be observed that since the time interval between time instances 235 and 240 may not be a multiple of a slot interval. Thus, the starting of a field 212b at time instance 240 may not be aligned to a slot boundary. This may adversely affect the performance (in particular, the collision avoidance performance) in the network.

Thus, it may be appreciated from the foregoing description, that wireless device 110-A improves throughput performance, while still adhering to applicable standards. The description is continued with an illustration of the internal details of wireless device 110-A in an embodiment.

### 6. Wireless Device

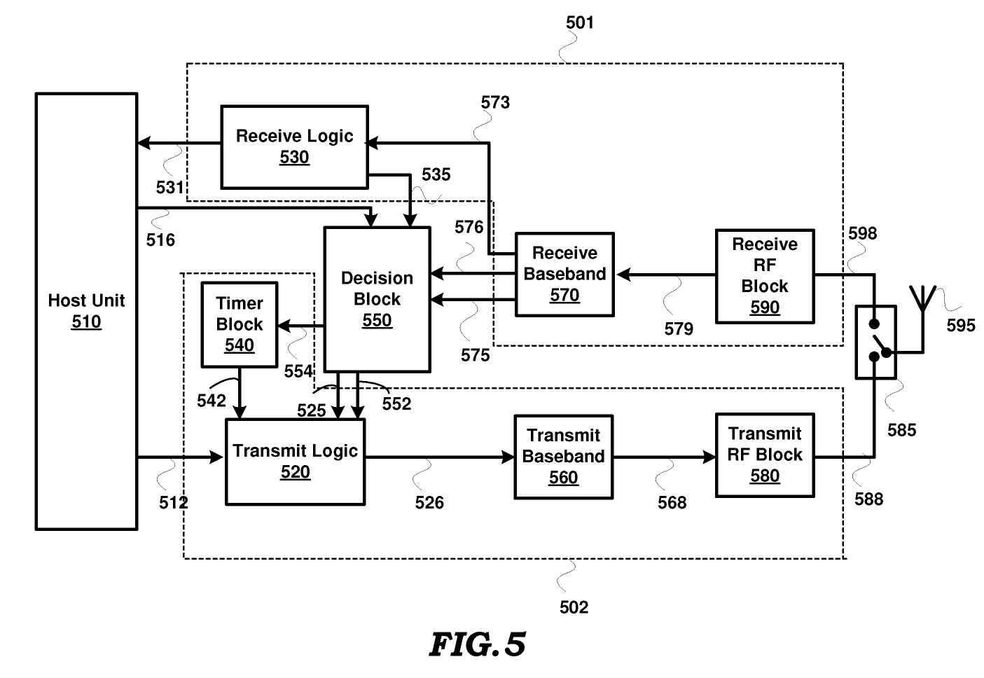

FIG. 5 is a block diagram of wireless device 110-A in an embodiment. The diagram is shown containing host unit 510, transmit logic 520, receive logic 530, timer block 540, decision block 550, transmit baseband 560, receive baseband 570, transmit RF block 580, receive RF block 590, switch 585 and antenna 595. Transmit logic 520, transmit baseband 560 and transmit RF block 580 may be referred to as transmit block 502, while receive logic 530, receive baseband 570, and receive RF block 590 may be referred to as receive block 501. Transmit block 502 and receive block 501 together represent a transceiver. Each component is described in detail below.

Host unit 510 may be any electronic device, and perform corresponding operations. For example, host unit 510 may be a PDA (personal digital assistant). The unit may contain various input/output (e.g., keys, display panels, audio/video output, etc.) components or just interfaces for the corresponding components.

Switch 585 may be controlled by host unit 510 (connection not shown) to connect antenna 595 either to receive RF block 590 via path 598, or transmit RF block 580 via path 588 depending on whether wireless device 110-A needs to receive or transmit.

Receive RF block 590 receives an RF signal carrying data packets from switch 585 via path 598, demodulates the RF signal, and provides a downconverted/demodulated (baseband) analog signal carrying data to receive baseband 570 via path 579. In alternative embodiments, receive RF block 590 may provide the baseband signal in digital form.

Receive baseband 570 performs analog to digital conversion of an analog signal received from receive RF block 590, and may perform operation such as filtering (to remove noise), DC offset removal, de-interleaving, error correction, FFT (fast Fourier transform assuming OFDM techniques are employed) etc., to extract data packets from the received signal. Receive baseband 570 forwards the data packets to receive logic 530.

Transmit RF block 580 receives an analog signal carrying data packets from transmit baseband 560 on path 568, and performs the radio frequency (RF) related operations such as modulating the carrier with the analog signal. Transmit RF block 580 provides an RF signal carrying the data packets to switch 585 via path 588.

Transmit baseband 560 receives transmit data from transmit logic 520, performs operations on the data such as scrambling, interleaving, IFFT (inverse fast Fourier transform assuming OFDM techniques are employed), and digital to analog conversion to generate an analog signal carrying the data. Transmit baseband 560 provides the analog signal to transmit RF block 580.

Receive logic 530 receives data packets from receive baseband 570 via path 573 and processes the received data. Processing may include filtering of data in the data packets, decryption of data (assuming data was transmitted in encrypted form), data integrity checks etc., and forwards the data to host unit 510 on path 531. Transmit logic 520 receives data for transmission from host unit 510, and processes the data. Processing may include encryption of data (assuming data is to be transmitted in encrypted form), addition of data integrity checksums etc, and forwards the data packets to transmit baseband 560 on path 526. Transmit logic 520 also receives one or more qualifying signals (depending on the specific implementation) from decision block 550, as described below.

Timer block 540 may contain one or more timers/counters used to measure intervals such as the DIFS period, back-off interval etc. Timer block 540 provides an indication of an expiry of a time interval (DIFS, back-off or any other used in the implementation) to transmit logic 520.

Decision block 550 receives status signals (such as status signals 404-407 of FIGS. 4a/4b) on path 575, and qualifying signals on path 576 from receive baseband 570. Decision block 550 may also receive a qualifying signal from receive logic 530 on path 535. Decision block 550 operates to generate decision signals (such as signals 408 and 409 of FIG. 4a/4b), and abort signal 499 (FIGS. 4a/4b) based on processing of the input signals received, and provides the signals to timer block 540 (path 554) and transmit logic 520 (paths 552 and 525). The logic implemented in decision block 550 may be configured by host unit 510 via path 516.

Transmit logic 520, receive logic 530, timer block 540, and decision block 550 perform the MAC (Medium Access Control) level operations, while transmit baseband 560, receive baseband 570, transmit RF block 580, and receive RF block 590 perform the PHY (physical) layer operations according to the 802.11 standard.

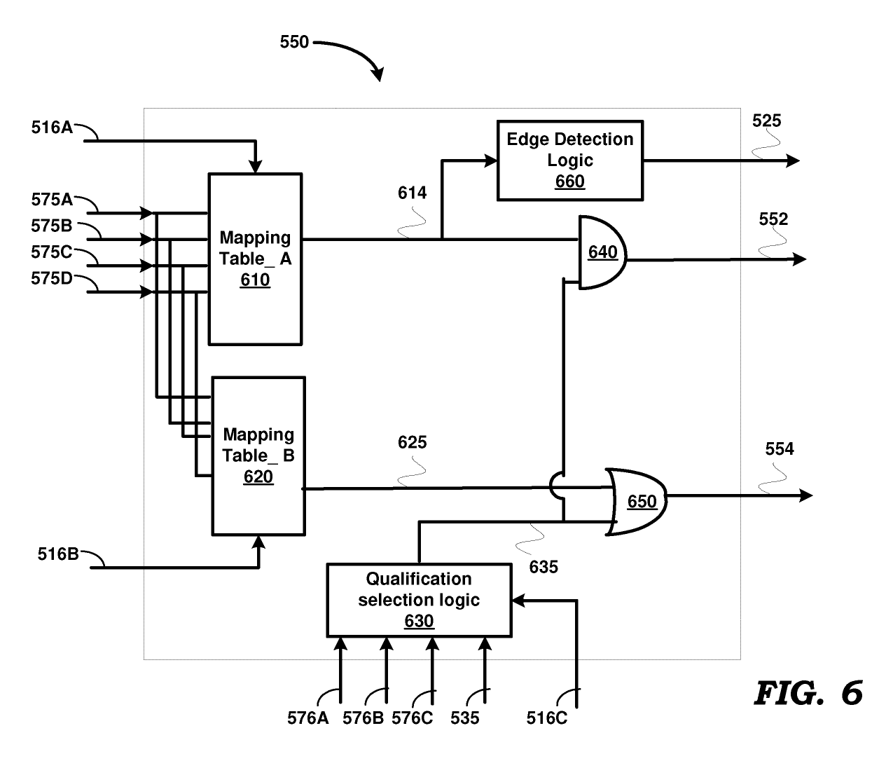

The internal details of decision block 550 in an embodiment are described next with respect to FIG. 6.

### 7. Decision Block

FIG. 6 is a block diagram illustrating the internal details of decision block 550 in one embodiment. The diagram is shown containing mapping table_A(610), mapping table_B(620), qualification selection logic 630, AND gate 640, OR gate 650, and edge detection logic 660. Each component is described in detail below.

Mapping table_A 610 is shown as receiving four status signals (status signals 404-407 of FIG. 4) on paths 575A through 575D respectively. The signals may be generated by corresponding circuitry in receive baseband 560 (FIG. 5). Mapping table_A 610 internally generates a logical function of the inputs 575A-575D, and generates an output on path 614. The signal on path 614 is thus the result of the operation of the logical function stored/implemented in mapping table_A 610. The logical function implemented in mapping table_A 610 may be any one of 2̂16 functions (assuming 4 input signals), and may be selected/configured based on input 516A from host unit 510 (FIG. 5). Output 614 is provided as one input to AND gate 640.

As an example, if reliability of status signal 406 (802.11a preamble detection signal) is lower than that of status signal 407 (802.11b preamble detection signal), and if energy at antenna (as indicated by status signal 404) is not as reliable, for example, due to lot of activity in adjacent channels as in-band energy (as indicated by status signal 405) then the following mapping table logic might be used:

Signal 614=(status signal 404 AND status signal 406) OR (status signal 407) OR (status signal 405).

As another example, if energy at antenna is to be ignored completely, and if there are interference sources in the channel of interest (such as carrier waves, cordless phone transmissions etc) causing false detection of in-band energy, then the following mapping table configuration might be used:

Signal 614=(status signal 405 AND status signal 406) OR (status signal 407). Thus, it may be appreciated that the configurability of combinatorial logic in mapping table_A 610 helps in taking a decision on valid packet either based only on energy or preamble detection, or both, with energy weight associated with only a given type of preamble detect (11a or 11b). This provides the flexibility to configure the mapping table for any kind of environment and mitigate the effect of interference on the transmit throughput.

Mapping table_B 620 is also shown as receiving the four status signals (status signals 404-407 of FIG. 4), and may be implemented similar to mapping table_A 610, and the description is not repeated. Output 625 generated by mapping table_B 620 is provided as an input to OR gate 650.

Qualification selection logic 650 is shown as receiving four qualification signals, three from receive baseband 570 (via paths 576A-576C), and one from receive logic 530 via path 535. The signals are phase shifted (asserted at different time instances), with the degree of phase shifting determining the specific time instance at which signal 552 would indicate whether the channel is available or not.

Qualification selection logic 650 selects one of the four signals, and forwards the selected signal on path 635 to AND gate 640 as well as OR gate 650. Qualification selection logic 650 also receives a selection value (configurable externally by a user, human or application) from host unit 510 on path 516C specifying which one of the four signals 515A-515D is to be selected. Thus qualification selection logic 650 may be implemented as a multiplexer, which selects one of the inputs on path 635 depending on the value on path 516C.

In an embodiment, qualification signal 576A corresponds to a time instance at which a valid SS field can be detected in the channel, 576B to detection of a valid LS field in the channel, 576C to detection of a valid PLCP header in the channel, and 535 to detection of a valid MAC header signals 576A-576C are contained in path 576, and signals (516A-516C in path 516. Similar convention applies elsewhere (e.g., signals 575A-575D are in path 575).

AND gate 640 provides the logical AND of signals 614 and 635 on path 552. OR gate 650 provides the logical OR of signals 614 and 635 on path 554. In an embodiment, signals on paths 552 and 554 respectively correspond to signals 409 and 408 respectively (of FIGS. 4A and 4B).

Edge detection logic 660 receives signal 614, and provides an output signal on path 525 (which, in an embodiment corresponds to signal 499 of FIGS. 4A and 4B) to transmit logic 520. Since the input to edge detection logic 660 is a result of a logical function of status signals 575A-575D, edge detection logic 660 effectively determines whether the current reception (signal on the channel) is to be aborted. A decision to abort reception is determined (i.e., a false detect condition is determined) if either an 802.11a packet/preamble detection signal (such as 406 of FIGS. 4A and 4B), or an 802.11b packet/preamble) detection signal (such as 407 of FIGS. 4A and 4B) goes to logic ‘1’ (deasserted) after temporarily being asserted, or if the energy level detected (indicated by signals 404, 405 of FIGS. 4A and 4B) falls below the threshold, without any indication from the Packet Detect mechanism (signals 406/407). Thus, the output of edge detection logic 660 is used to indicate to transmit logic 520 that the countdown of DIFS+backoff interval that was happening in the background (for example, as indicated by fields 413 and 414 in FIG. 4A) was valid, and that transmission can commence once the backoff count reaches zero.

It may be appreciated from the above description that a decision to transmit a data packet may be taken based on a desired level of certainty being obtained regarding the status of the channel. Thus, wireless device 110-A may be implemented in a manner described above to determine an optimal time instance to transmit data packets.

At least in an 802.11WLAN environment, a similar decision to transmit may be required to be made to complete data transfer. Transmission of a data packet often requires an acknowledgment (ACK) from the destination receiver. The detection of a valid ACK may be impaired by the presence in the channel of interference signals due to effects noted above. In the event an (ACK) is not received within a predetermined time duration, the transmitter may be required to retransmit the previously transmitted data packet as early as possible, so as not to affect network throughput performance.

Therefore, a determination of an optimal time instance to retransmit the data packet may be desirable. The manner in which retransmit time instance may be determined optimally is described below. First, a prior approach to retransmission is illustrated with a diagram.

### 8. Prior Retransmit Sequence

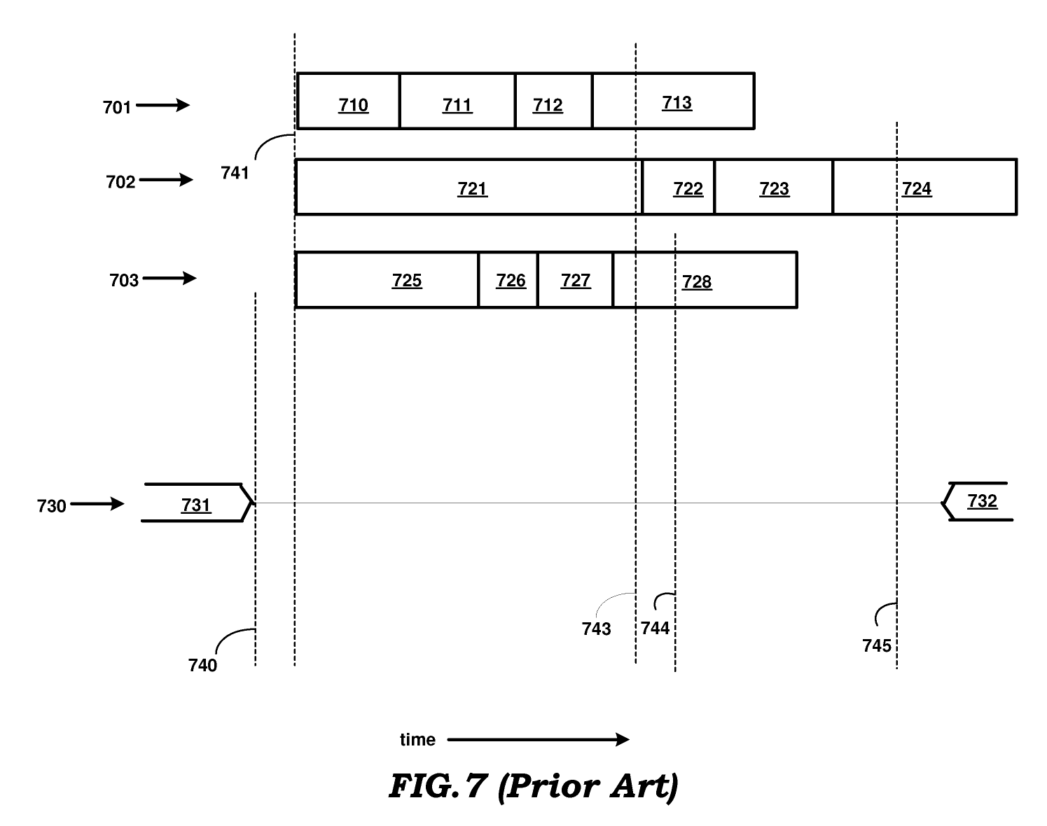

FIG. 7 is a timing diagram of a (prior) approach to retransmission. Merely, as an illustration, a retransmission approach as might be employed in the environment of FIG. 1 assuming operation in the HCCA mode according to the 802.11e WLAN standard is assumed. It is also assumed for the purpose of the following description that AP 110-F of FIG. 1 implements the hybrid co-coordinator (HC) operations as specified by the 802.11e standard.

Waveform 730 represents a sequence of tasks performed for transmission/retransmission in wireless device 110-A. In particular, 731 represents the last transmit packet transmitted by wireless device 110A, which ends at time instance 740. Field 732 is described below.

Signals 701, 702 and 703 are example signals that might be received as a response (ACK—acknowledgment) to the transmission of packet 731. All three signals 701, 702 and 703 are shown as (possibly) commencing at time instance 741. In particular, signal 701 may represent an ACK according to 802.11a specification, signal 702 may represent an ACK according to 802.11g (long preamble) specification, signal 701 may represent an ACK according to 802.11g (short preamble) specification.

Fields 710, 711, 712 and 713 of signal 701 correspond to SS header, LS header, PLCP header, and actual ACK payload data respectively. Fields 721, 722, 723 and 724 of signal 702 correspond to (long) preamble, SFD (Start Frame Delimiter) field, PLCP header, and actual ACK payload data respectively. Fields 725, 726, 727 and 728 of signal 703 correspond to (short) preamble, SFD field, PLCP header, and actual ACK payload data respectively.

As noted above, wireless device 110A ends transmission of a data packet at time instance 740. According to 802.11 standard, wireless device 110A expects an ACK packet to be received by time instance 741 (occurring at the end of a SIFS−short inter frame sequence interval from time instance 740). As specified by the 802.11 standard, if no ACK packet is received by time instance 741, wireless device 110A may retransmit data packet 731 at the end of a predetermined time interval specified by the standard. The predefined time interval is PIFS (SIFS+one slot) in case of HCCA (or it is DIFS+random back-off interval in case of EDCA mechanism), where DIFS denotes a DCF interframe space, PIFS denotes a PCF interframe space, SIFS denotes a short interframe space, and EDCA denotes Enhanced Distributed Coordination Access mechanism as specified by the 802.11e standard. However, it may be difficult to reliably determine whether any of signals 701, 702 or 703 are received (and thus present in the channel or not), especially if interference/noise is present in the channel.

In the absence of such reliability, wireless device 110A may be designed to delay retransmission till the end of a period (called a timeout) within which valid indication must have arrived. Thus, if an 802.11a ACK packet (such as signal 701) is expected (but not reliably detected) wireless device 110-A may have to wait till time instance 743. If an 802.11g short preamble type ACK packet (such as signal 703) is expected (but not reliably detected) wireless device 110-A may have to wait till time instance 744, while if an 802.11g long preamble type ACK packet (such as signal 702) is expected (but not reliably detected) wireless device 110-A may have to wait till time instance 745. In FIG. 7, time instance 743 would occur one slot-time after end of field 712, time instance 744 would occur one slot-time after end of field 727, and time instance 745 would occur one slot-time after field 723.

Thus, it may be seen from the above description that due to lack of a reliable determination of the channel status, retransmission may be substantially delayed leading to decrease in throughput performance. A worst case delay occurs when wireless device 110-A must wait till end of 802.11g long preamble type ACK packet such as signal 702. Thus, a worst case scenario is when wireless device 110-A transmits later than time instance 745, as denoted by field 732. Further, although not shown in FIG. 7, it may also happen that wireless device 110A might lose its retransmit opportunity after timeout occurs if another wireless device gains access to the channel before wireless device 110-A.

While the description above has been made with respect to retransmission in the HCCA mode, in general similar retransmission delays may also occur when in other operating modes including, for example, an EDCA (Enhanced Distributed Coordination Access) mode according to the 802.11e specification. Several aspects of the present invention enable more reliable determination of a signal present in the channel leading to an optimal determination of retransmit time instance, as described below. First, a state transition diagram illustrating the possible sequence of states in wireless device 110-A in determining channel status.

### 9. State Transition Diagram

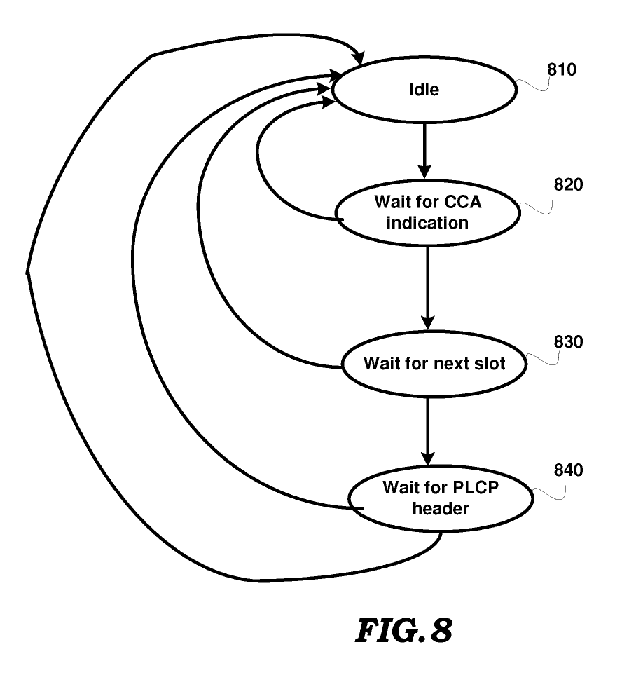

FIG. 8 is a state transition diagram illustrating the states through which wireless device—110A may sequence in determining channel status. In each state, transmit logic in wireless device 110-A monitors the values of status signals, and transitions to a next state as described below. The transition from one state to another is based both on values of corresponding status signals as well as a desired degree of certainty.

Following transmission of a data packet, transmit logic in wireless device 110-A enters IDLE state 810.

Transmit logic then transitions to state 820 in which it waits for a CCA signal to indicate channel status. If no CCA indication is received (i.e., no detection of signal in the channel), and if the lack of such indication is deemed to be reliable enough (exceeding a desired degree of certainty) transmit logic decides that no ACK is received, declares a timeout, and transitions back to IDLE state 810. Transmit logic may then start retransmit procedure for data packet.

However, if in state 820, if CCA indication is received and this indication is deemed sufficiently reliable, transmit logic transitions moves to state 830, in which it waits till a next slot boundary. State 830 gives sufficient time for CCA indication to stabilize. At the end of period indicated by 830 the CCA indication is more robust and reliable. If an earlier CCA assertion, especially packet detect CCA (11a preamble or 11g preamble detection) (in state 820), is de-asserted, transmit logic declares a timeout, and transitions back to IDLE state 810. De-assertion of packet detect CCA indicates that the received packet is dropped and earlier indication at stage 820 was false packet detect. Transmit logic may then start retransmit procedure for data packet.

If at the end of period 830, CCA indication remains active, including packet detect CCA (11a type or 11g type packet), this indicates greater degree of certainty on received signal. Transmit logic monitors for an indication of detection of a valid preamble type. Transmit logic then transitions to state 840. The duration for which transmit logic remains in 840 depends on preamble-type of ACK packet expected. The preamble may be an 802.11a type preamble, 802.11b short preamble, or 802.11b long preamble.

In state 840, transmit logic waits for the detection of a valid PLCP header. PLCP header detection may be deemed sufficiently reliable. If in state 830, no valid preamble was detected, transmit logic may transition back to state 810. Transmit logic may then start retransmit procedure for data packet.

If a valid PLCP header indication is received, transmit logic abandons timeout mechanism since response packet is bound to come after PLCP header indication. If no valid PLCP header is detected, transmit logic declares a time out, and transitions back to state 810. Transmit logic may then start retransmit procedure data packet.

The above operations are illustrated with respect to example timing diagrams below.

### 10. Improved Retransmit Sequence

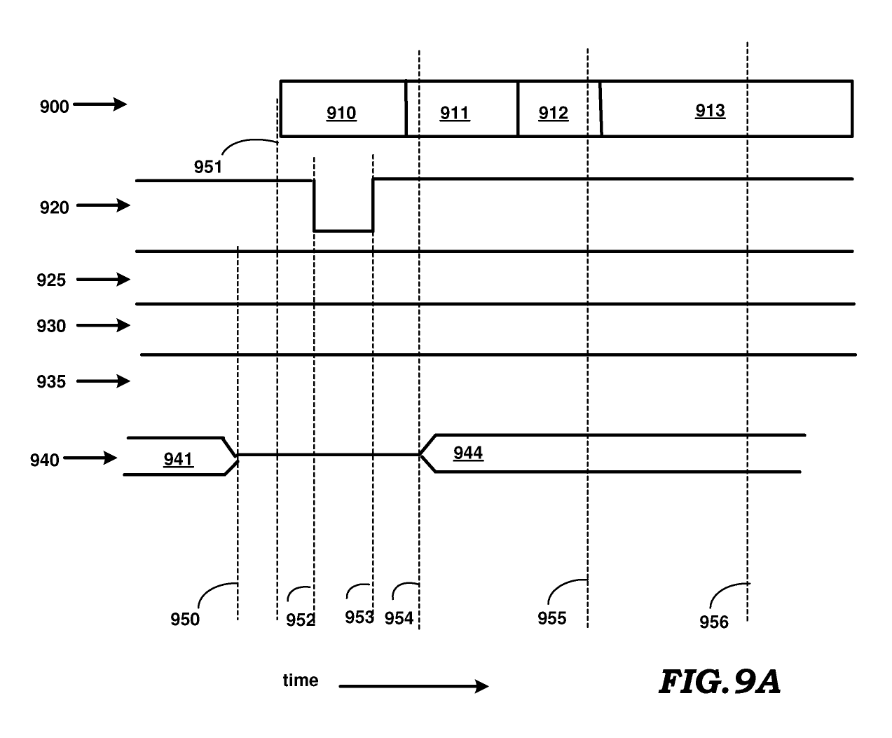

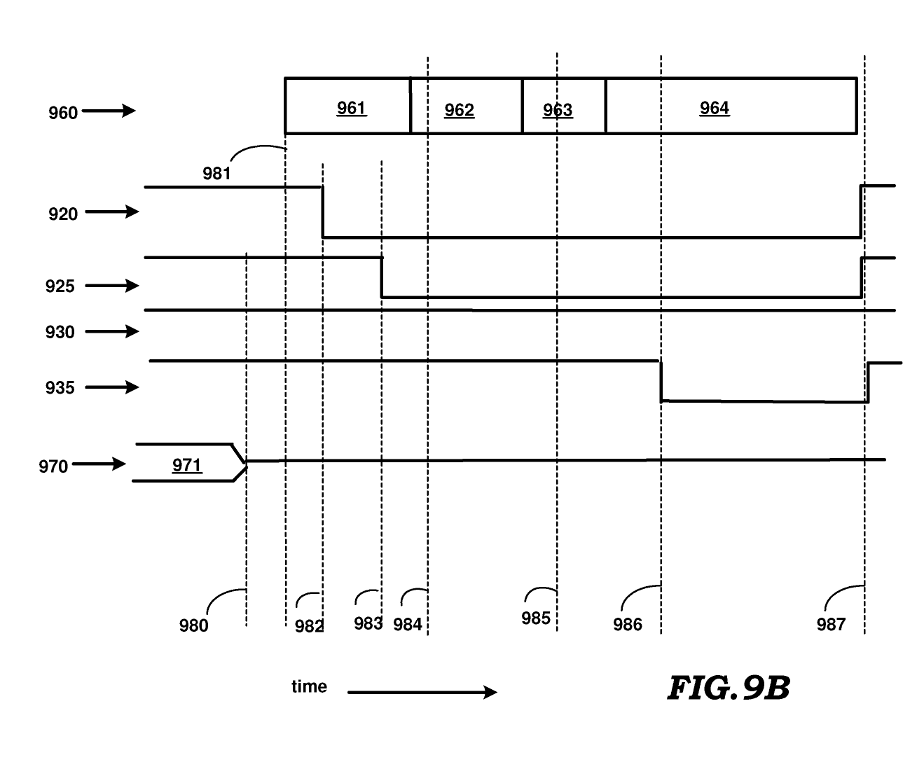

FIG. 9A is a timing diagram illustrating an improved retransmit sequence in wireless device 110A. Merely as an example, the description is provided with respect to a scenario in which an 802.11a type of ACK packet is expected. However, similar approaches can be used in other scenarios as well.

Waveform 940 represents a sequence of tasks performed for (improved) transmission/retransmission in wireless device 110-A according to an aspect of the present invention. In particular, 941 represents the last transmit packet transmitted by wireless device 110A, which ends at time instance 950. Field 944 is described below.

Signal 900, shown starting at time instance 951, may represent either a valid ACK packet to the data packet (field 941) transmitted by wireless device 110A, or represent noise due to effects such as those noted earlier. In the event where waveform 900 represents a valid 802.11a ACK packet, field 910 (SS) denotes a short-sequence preamble, field 911 (LS) is a long-sequence preamble, field 912 is a PLCP (Physical Layer Convergence Procedure) header, and field 913 contains the ACK information.

Status signal 920 may be asserted if the signal energy in the channel as seen/received by an antenna, but contained within a bandwidth of interest crosses a specified threshold. The bandwidth of interest may correspond to the bandwidth used for transmission/reception by devices in the environment of FIG. 1.

Status signal 925 may be asserted if a valid 802.11a preamble is detected. Thus, with respect to FIG. 9A, status signal 920 may be designed to indicate the status based on, for example, analyzing the contents in fields 910 and 911 of signal 900 (transmitted by some other wireless devices). How soon (early) status signal 925 is asserted may be based on an accuracy with which the contents of fields 910 and 911 may be determined given a signal strength, other interference sources, design of the logic for signal 920 etc.

Status signal 930 may be asserted if a valid 802.11g preamble (long preamble or short preamble type packet) is detected. How soon (early) status signal 930 is asserted may be based on an accuracy with which the contents of an 802.11g preamble may be determined given a signal strength, other interference sources, design of the logic for signal 930 etc. Status signal 935 may be asserted if a valid PLCP header is detected. All status signals are assumed to be asserted logic low.

As noted above, wireless device 110A ends transmission of a data packet at time instance 950. Wireless device 110-A may then make a decision to transmit or not at time instances 954, 955 or 956. Time instance 954 represents a time point one slot interval from time instance 951, time instance 955 represents a time point two slot intervals from time instance 951, and 956 indicates a time instance by which the PLCP header indication should have been received if the receive packet were to be a valid 802.11 packet. This time period is different for 11a, 11g short and 11g long preamble. In particular, time instance 956 indicates the time point by which the PLCP header indication should have come if the received packet is a valid 802.11 packet. FIG. 9A illustrates a scenario in an 802.11a only network where SIFS time is 16 usec and slot time is 8 usec. SS, LS and PLCP header are respectively 8 microseconds, 8 microseconds and 4 microseconds long.

At time instance 952, status signal 920 is shown as going to logic low (0) indicating detection of energy (exceeding a threshold) in the channel lying within a transmit/receive band of wireless device 110A. At time instance 953, status signal 920 is shown as being de-asserted, indicating that the earlier assertion was a false detection.

Status signals 925, 930 and 935 are shown as remaining at logic 1 (de-asserted) in FIG. 9A, indicating that valid preamble fields and PLCP header of 802.11a or 802.11g signals have not been detected.

Assuming that time instance 954 denotes the time when processing of status signals 920, 925, 930 and 935 reaches a desired degree of certainty, wireless device 110-A checks the values of the status signals, notes that the status signals do not indicate a valid 802.11 ACK packet and commences retransmission procedure of the last sent transmit packet (field 941) at time instance 954, as indicated by field 944.

In FIG. 9A, a ‘degree of certainty’ about the status of the channel is deemed to have exceeded a desired threshold at time instance 954. For greater degree of certainty, wireless device 110-A checks the values of the status signals in the next slot interval, denoted in FIG. 9A by time instance 955. Thus, by selecting a time instance deemed to provide indication of channel status with a desired degree of certainty, and also selecting a desired combination of status signals to be processed, the desired degree of certainty may be varied.

FIG. 9B illustrates a scenario wherein a valid data packet is detected in the channel. Signal 960 (shown as starting at time instance 981) represents an 802.11a ACK packet, and fields 961, 962, 963 and 964 represent the SS, LS, PLCP and ACK data payload respectively. Waveform 970 represents a retransmit sequence in wireless device 100-A. Transmission of a last packet (971) is shown as ending at time instance at 980.

Status signal 920 is shown as being asserted at time instance 982, status signal 925 is shown as being asserted at time instance 983, and status signal 935 is shown as being asserted at time instance 986. Status signal 930 remains de-asserted. As noted above, wireless device 110-A may check the values of status signals at time instances 984, 985 and 986 (coinciding with 1 slot delay, 2 slot delays and configurable delay from start of packet 960. The configurable delay depends on worst case PLCP header indication arrival time).

At time instance 984, wireless device 110-A notes that both signals 920 and 925 are asserted, thus indicating the possible presence of a valid 802.11 ACK packet. Assuming that wireless device 110-A is configured to wait till greater certainty about channel status is obtained, wireless device 110-A waits for one more slot interval (till time instance 985). At time instance 985, wireless device 110-A notes that status signal 920 and 925 are still asserted. Continued assertion of status signals 920 and 925 at this time is stronger indication that the received packet is a valid 802.11 packet (since PHY/physical layer has got a correspondingly (and sufficiently) longer time for estimation, and also since 925 is still asserted, this indicates a greater confidence level regarding the received signal). A next indication is 935 (which should occur soon after field 963). Continued assertion of signal 925 at time instance 985 indicates a valid 802.11a packet. From this indication (signal 925), transmit logic can estimate the stage at which it is in, and a worst possible time by which assertion of 935 would occur. Transmit logic waits for assertion of signal 935, and on such assertion determines that a valid ACK packet has been received.

It may also be noted that since the retransmit decision (considering the received packet is not a valid 802.11 packet) is taken at time instances 984/985 (which are aligned to slot intervals) slot synchronization is maintained at earliest possible retransmission.

Thus, it may be appreciated that wireless device may examine the values of status signals at different time instances corresponding to different degrees of certainty till it determines the channel status. In contrast, the prior retransmission technique illustrated in FIG. 7, relies on the indication of a single status signal which may not provide a desired degree of certainty.

### 11. Conclusion

While various embodiments of the present invention have been described above, it should be understood that they have been presented by way of example only, and not limitation. Thus, the breadth and scope of the present invention should not be limited by any of the above described embodiments, but should be defined only in accordance with the following claims and their equivalents.

1. A method of determining an optimal time instance to transmit packets on a wireless network, said method being performed in a wireless device, said method comprising:
forming packet for transmission on said wireless network;
commencing a preparation procedure for transmission of said packet;
receiving a plurality of status signals, each status signal indicating a status of a channel at a corresponding time instance on said wireless network;
determining a degree of certainty with which said channel is free for transmission by examining said plurality of status signals; and
transmitting said packet at an end of said transmission procedure if said degree exceeds a desired threshold.

2. The method of claim 1, wherein said plurality of status signals comprise a first signal indicating whether a medium signal on said wireless network at a first time instance represents a valid preamble of a packet transmitted by another device in said wireless network, wherein said degree of certainty is enhanced if said first signal indicates that said valid preamble is not detected.

3. The method of claim 2, wherein said plurality of status signals further comprises a second signal indicating whether energy level on said wireless network where said wireless device is located exceeds a second threshold at a second time instance, a third signal indicating whether energy level within a band of interest on said wireless where said wireless device is located exceeds a third threshold at a third time instance, wherein said second time instance is before said third time instance and said third time instance is before said first time instance.

4. The method of claim 3, further comprising examining a plurality of qualifying signals, which respectively tie said first time instance to a specific time instance in time domain.

5. The method of claim 4, further comprising providing a configuration data which can be configured by a user, wherein said configuration data specifies the specific ones of said plurality of status signals which are to be ignored or considered by said determining, and a manner in which the considered status signals are to be processed by said determining in forming said degree.

6. The method of claim 4, wherein said wireless device and said wireless network operated according to 802.11 standard, and wherein said first signal indicates whether said medium signal represents a preamble according to 802.11a, wherein said plurality of status signals further comprises a fourth signal indicating whether said medium signal on said wireless network at a fourth time instance represents a valid preamble of a packet according to 802.11b, wherein said degree of certainty is enhanced if said fourth signal indicates that said valid preamble is not detected according to 802.11b.

7. The method of claim 1, wherein said determining determines a second degree of certainty with which a medium signal on said channel does not represent a valid acknowledgment to said packet by examining said plurality of status signals, said method further comprising:
retransmitting said packet if said second degree of certainty exceeds a second threshold.

8. A transceiver to transmit and receive packets on a wireless network, said transceiver comprising:
a timer block designed to count a time interval;
a transmit block to form a packet for transmission on said wireless network, said transmit block causing said timer block to start counting said time interval;
a receive block to generate a plurality of status signals, each status signal indicating a status of a channel at a corresponding time instance on said wireless network; and
a decision block examining said plurality of status signals to determine a time instance after which to transmit said packet, wherein said transmit block transmits said packet at an end of said time interval after said time instance.

9. The transceiver of claim 8, wherein said decision block determines a degree of certainty with which said channel is free for transmission by examining said plurality of status signals and indicates said time instance when said degree of certainty exceeds a desired threshold.

10. The transceiver of claim 9, wherein said decision block comprises:
a mapping table receiving said plurality of status signals and performing a logical operation of said plurality of status signals to generate a value representing whether said degree of certainty exceeds said threshold.

11. The transceiver of claim 10, wherein said decision block further comprises:
a qualification selection logic which generates a signal representing a time instance after which the result of said logical operation is to be represented as said value.

12. The transceiver of claim 11, wherein each of said mapping table and said qualification selection logic is configurable by a user.

13. The transceiver of claim 11, wherein said qualification selection logic comprises a multiplexer which receives from said receive block a plurality of qualifying signals each with a different level of phase shift, and forwards the selected on of the plurality of qualifying signals as a selected qualifying signal, said transceiver further comprising:
an AND logic performing a logical AND operation of said selected qualifying signal and an output of said mapping table to generate said value.

14. The transceiver of claim 13, further comprising:
an OR logic performing a logical OR operation of said selected qualifying signal and said output of said mapping table to generate an enable signal which starts count of said time interval.

15. The transceiver of claim 11, wherein a protocol underlying said wireless network requires a retransmission of said packet if an acknowledgment packet is not received in a pre-specified interval after transmission of said packet, wherein said mapping table generates a second value indicating whether a second degree of certainty with which a medium signal on said channel does not represent a valid acknowledgment to said packet exceeds a second threshold by examining said plurality of status signals;
wherein said transmit block retransmits said packet if said value indicates that said second degree of certainty exceeds a second threshold.

16. The transceiver of claim 11, wherein said plurality of status signals comprise a first signal indicating whether a medium signal on said wireless network at a first time instance represents a valid preamble of a packet transmitted by another device in said wireless network, wherein said degree of certainty is enhanced if said first signal indicates that said valid preamble is not detected.

17. The transceiver of claim 16, wherein said plurality of status signals further comprises a second signal indicating whether energy level on said wireless network where said wireless device is located exceeds a second threshold at a second time instance, a third signal indicating whether energy level within a band of interest on said wireless where said wireless device is located exceeds a third threshold at a third time instance, wherein said second time instance is before said third time instance and said third time instance is before said first time instance.

18. The transceiver of claim 17, wherein said wireless device and said wireless network operate according to 802.11 standard, and wherein said first signal indicates whether said medium signal represents a preamble according to 802.11a, wherein said plurality of status signals further comprises a fourth signal indicating whether said medium signal on said wireless network at a fourth time instance represents a valid preamble of a packet according to 802.11b, wherein said degree of certainty is enhanced if said fourth signal indicates that said valid preamble is not detected according to 802.11b.

19. A wireless device for operation in conjunction with a wireless network, said wireless device comprising:
a host unit generating data for transmission on said wireless network; and
a transceiver to transmit said data on said wireless network, said transceiver comprising:
a transmit block to form a packet for transmission on said wireless network;
a receive block to generate a plurality of status signals, each status signal indicating a status of a channel at a corresponding time instance on said wireless network; and
a decision block examining said plurality of status signals to determine a time instance after which to transmit said packet,
wherein said transmit block transmits said packet after said time instance.

20. The wireless device of claim 19, wherein said transceiver further comprises:
a timer block designed to count a time interval, wherein said decision block determines a degree of certainty with which said channel is free for transmission by examining said plurality of status signals,
wherein said transmit block transmits said packet at an end of said time interval if said degree exceeds a desired threshold

21. The wireless device of claim 20, wherein said decision block comprises:
a mapping table receiving said plurality of status signals and performing a logical operation of said plurality of status signals to generate a value representing whether said degree of certainty exceeds said threshold; and
a qualification selection logic which generates a signal representing a time instance after which the result of said logical operation is to be represented as said value.

22. The wireless device of claim 19, wherein said wireless network operates according to 802.11 protocol.
